(19) United States
(12) Patent Application Publication
(10) Pub. No.: US 2009/0300437 A1
(43) Pub. Date: Dec. 3, 2009

(54) DATA REPOSITORY AND ANALYSIS SYSTEM FOR REMOTELY MANAGED TEST AND MONITORING DEVICES

(76) Inventors: William H. Bhame, Madison, GA (US); James M. O'Brien, Marietta, GA (US)

Correspondence Address: Adorno & Yoss, LLC, 1349 West Peachtree Street, NE, Suite 1500, Atlanta, GA, 30309, US

(21) Appl. No.: 12/255,743

(22) Filed: Oct. 22, 2008

Related U.S. Application Data
(60) Provisional application No. 61/130,128, filed on May 28, 2008.

(51) Int. Cl. G06F 15/173; G06F 11/07

(52) U.S. Cl. 714/57; 709/224; 714/E11.025

(57) ABSTRACT

A data repository and analysis system manages test and monitoring end devices through hub/routing functionality implemented on custom or generic platform devices and wired and/or wireless communication with a backbone infrastructure. Hub/routing devices manage test and monitoring end devices locally collecting data, configuring the end devices, etc. Data collected by the hub/routing devices is gathered at the data repository and analysis system, which also manages the hub/routing devices by sending them instructions, monitoring their operations, updating operational parameters, and the like. In addition to analyzing gathered data and providing reports to designated third parties, the data repository and analysis system may monitor alert conditions based on gathered data and provide alerts to designated recipients if such a condition is detected.

### RELATED APPLICATIONS

This application claims the benefit of U.S. Provisional Application Ser. No. 61/130,128 filed on May 28, 2008, which is hereby claimed under 35 U.S.C. §119(e). The referenced Provisional Application is incorporated herein by reference.

### BACKGROUND

Test and monitoring devices are used in industrial, biomedical, and other applications. These devices are typically designed for performing a specific test/measurement and then provide the data through downloading, wired communication, wireless communication, and so on. A typical and increasingly growing application of test/measurement devices is in healthcare industry. Instead of performing all monitoring and testing at a healthcare facility, doctors are able to provide patients with a portable measurement device and have the patient monitor a particular condition at home. Commonly, the patient needs to return the device to the doctor's office or connect to the office through a modem connection and upload the data, which is then reviewed by the healthcare provider(s).

Due to the variety and non-standard nature of test/measurement devices in healthcare, doctors may have to acquire expensive data processing/programming/communication equipment to manage the portable devices handed out to the patients. If a doctor's office desires to monitor multiple conditions through a variety of devices, it is reasonable to expect that they will have to invest in significant Information Technology (IT) infrastructure only to manage those devices. This not only reduces or eliminates the efficiency and value of home monitoring devices for the industry overall, but also prevents delivery of valuable healthcare services to patients.

Thus, critical resources are often dramatically underutilized resulting in increased cost as well as frustration of both patients and care-providers., the use of such test and monitoring devices does not improve efficiency, cost, or quality of healthcare significantly.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to a data repository and analysis system for managing test and monitoring end devices through hub/routing functionality implemented on custom or generic platform devices and wired and/or wireless communication with a backbone infrastructure. Hub/routing devices manage test and monitoring end devices locally collecting data, configuring the end devices, etc. Data collected by the hub/routing devices is gathered at the data repository and analysis system, which also manages the hub/routing devices by sending them instructions, monitoring their operations, updating operational parameters, and the like. In addition to analyzing gathered data and providing reports to designated third parties (e.g. healthcare providers), the data repository and analysis system may monitor alert conditions based on gathered data and provide alerts to designated parties (e.g. local emergency management services) if such a condition is detected.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a diagram illustrating major components of a test and monitoring device management system according to embodiments;

FIG. 2 illustrates major functional blocks of a data repository and analysis system according to embodiments;

FIG. 3 illustrates an example routing/hub device managed by a data repository and analysis system according to embodiments;

FIG. 4 is a conceptual diagram illustrating communications between major components of an example medical test and monitoring device management system according to embodiments;

FIG. 5 illustrates a networked environment where embodiments may be implemented;

FIG. 6 illustrates an example computing device where embodiments may be implemented; and

FIG. 7 is a flowchart of a process for managing test and monitoring devices by a data repository and analysis system according to embodiments.

### DETAILED DESCRIPTION

As briefly discussed above, test and monitoring devices may be managed locally by hub/routing devices, which in turn are managed by a data repository and analysis system over networked means enabling third parties to receive reports based on data analysis, to configure test and monitoring device functionality, and to receive alerts if predefined conditions are detected. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments are described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Furthermore, references are made and preferred embodiments are described in conjunction with a medical test and monitoring application. However, embodiments are not limited to medical applications. A data reporting and analysis repository system and associated routing/hub device and functionality for managing test and monitoring end devices may be implemented for any type of test and monitoring application including, but not limited to, industrial applications, security applications, and the like, using the principles described herein.

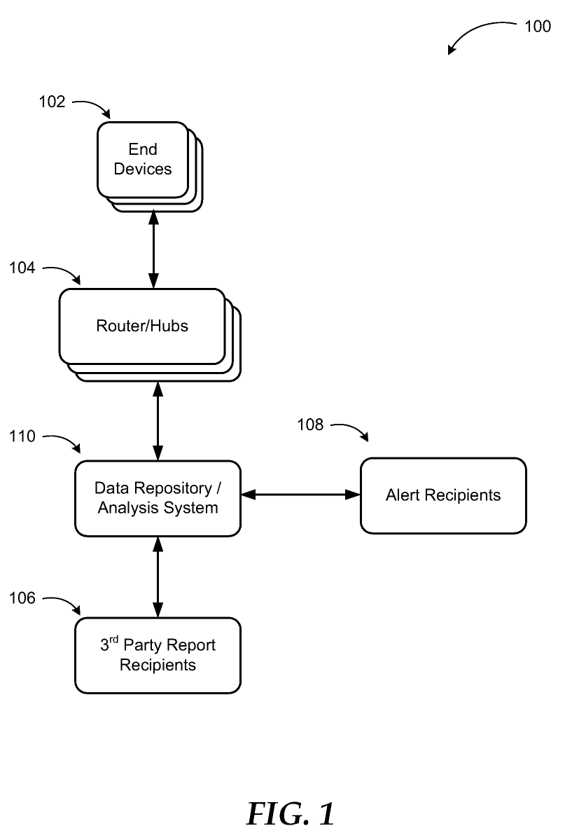

Referring to FIG. 1, diagram 100 of example major components of a test and monitoring device management system according to embodiments is illustrated. End devices 102 are typically portable test and monitoring end devices that collect data based on physical, chemical, and other types of measurements. These devices may vary from a variety of healthcare monitoring devices (e.g. blood pressure measurement devices, blood sugar measurement devices, heart functionality monitoring devices, and the like) to industrial test and monitoring devices that measure predefined processes.

In a system according to embodiments, one or more end devices 102 may be locally managed by a routing/hub device that communicates with the end devices through wired or wireless means (typically short range), provides instructions for operational parameters (measurement period, etc.), collects measurement data from the end devices, and communicates with the data repository and analysis system 110 through wired or wireless means (typically long range).

Routing/hub devices may be portable or stationary, may include some analysis capability on their own, and may perform additional tasks such as issuing alerts to designated recipients based on detected alert conditions from the managed end devices. Examples of routing/hub devices along with their communication and operational capabilities are discussed in further detail below.

At the heart of a system according to embodiments lies the data repository and analysis system 1 10. Data repository and analysis system 110 may be one or more integrated computer programs executed over a number of servers. Such as system may also include generic and custom software and hardware components. For example, data repository and analysis system 110 may be implemented as a hosted service by a service provider according to one embodiment. The service provider such as a communications network provider may manage subscribers' test and monitoring end devices through compatible routing/hub devices, collect data, analyze, and provide reports to designated third party report recipients 106. In addition, the service provider may also transmit alerts through designated means (cellular calls, electronic mails, PSTN calls, and so on) to predefined alert recipients 108 upon detecting an alert condition during the analysis of the collected data. Details and examples of such communications and operations are also described in more detail below.

A system according embodiments is not limited to the components described above. It may be implemented with fewer or additional components and functionality using the principles described herein.

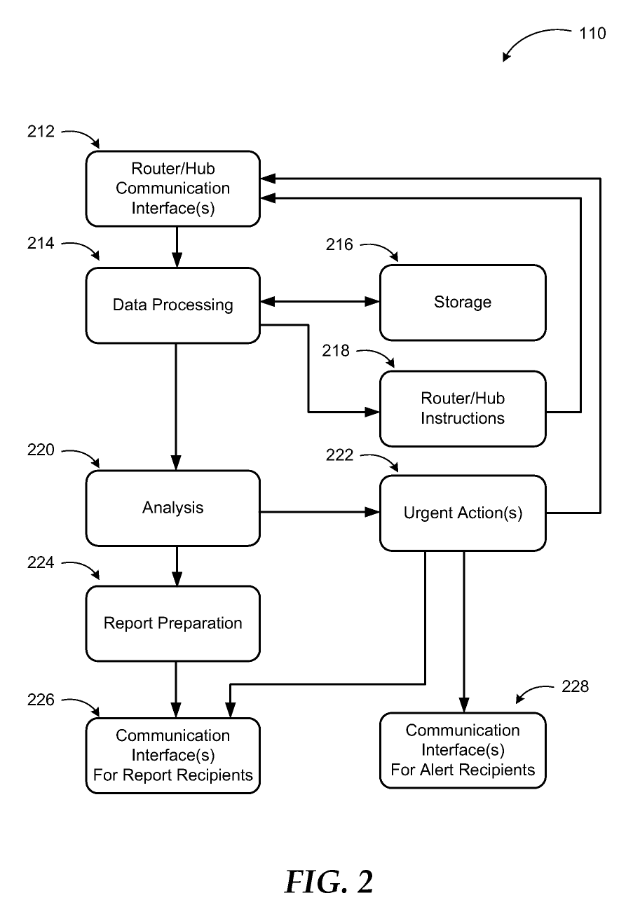

FIG. 2 illustrates major functional blocks of a data repository and analysis system according to embodiments. As briefly discusses above, the core functionalities of data repository and analysis system 110 include storage and analysis of collected data, report preparation, issuing alerts, and management of routing/hub devices. Each of these core functionalities may be handled by interconnected modules individually or by a single module.

Communication with the data source—routing/hub devices—is critical. In a system according to embodiments, routing hub devices of many kinds may be utilized. Thus, different communication interfaces/protocols may be necessary to communicate with those. Some devices may have standardized interfaces. Others may need to communicate with the data repository and analysis system first and configure their communication parameters. Moreover, the communication interfaces/protocols may need to be updated once in a while. All of these communication related tasks may be performed by the system's communication interface(s) module 212.

A routing/hub device may operate in conjunction with any test and monitoring device and communication end device configured to work through a standardized communication system. Such devices typically require some form of custom interface. The custom interfacing is accomplished through using an Application Programming Interface (API) specific for that end device (or a generic one for a device type). The routing/hub device may be configured to include one or more common APIs. Additional APIs may be loaded to the routing/hub device by the user or by the data repository and analysis system managing the routing/hub device as needed. Updates to end device APIs may also be performed automatically or manually as device configurations change or software is further developed.

Data processing module 214 may maintain operational data, process collected data, configure communication and interface parameters, receive user inputs and/or remote management instructions, and perform any other associated tasks. As such processing module 214 may involve the operations of one or more processors, temporary or permanent memory modules, and other hardware components. According to some embodiments, processing module 214 may facilitate storage (216) of collected data, analysis results, generated reports, operational parameters, and so on in local and/or remote data stores. Data processing 214 may also provide routing/hub configuration instructions 218 based on user inputs, analysis results, custom rules, and the like.

Router/hub instructions 218 are instructions related to one or more aspects of the router/hub device's operations. For example, a communication protocol, a data collection configuration, a data security configuration, and many other similar aspects may be instructed by the data repository and analysis system to the connected router/hub devices. The instructions may be based on policies such as templates for different types of devices, conditions monitored by the devices (e.g. medical conditions), user profiles, data recipient profiles, and the like. The instructions may be partially dependent on analysis results or independent from the analysis results.

Analysis module 220 essentially analyzes the collected data based on predefined rules. Subscribers of a system according to embodiments (e.g. healthcare provider receiving the report/data or the patient using the test and monitoring device) may select from a number of templates, but may also customize analysis rules. In addition to the basic analysis rules, configuration parameters such as how frequently a report should be prepared, who the report should be transmitted to, what format the report should be transmitted in, etc. can be defined by the user(s). According to an example scenario, a heart disease patient may use a heart monitor and a blood pressure monitor at their home. One of the test and monitoring devices may be connected through a wired connection (e.g. USB) and the other through a wireless connection (e.g. Bluetooth®) to a routing/hub device. The routing/hub device in turn may be managed by a data repository and analysis system managed by the local communication service provider. The patient may enter a profile and select among available options when subscribing to the service also defining who the recipients of the reports should be. The recipients—typically doctor's offices or pharmacies—may then customize their own parameters, such as which format they are to receive the reports (224).

Another functionality of the analysis module 220 may be determination of whether urgent actions (222) are needed such as issuing alerts. If the analysis detects a predefined condition that may require immediate attention, alerts may be issued to designated recipients such as emergency management officials, care providers, and so on. In some case, the devices may even be configured to perform actions in response to detection of alert conditions (e.g. administration of physical/chemical therapeutic actions).

For report transmission and alert transmission separate or common communication interfaces may be utilized. These communications may take place over wired or wireless, secure or public, short range or long range networks. A wide variety of communication means may be made available to the users for these purposes. Therefore, communication parameters may be managed by the system through distinct communication interface modules (226, 228).

Any communication between different components of a system implementing embodiments may be secure communications. For example, the data from the routing/hub device to the data repository and analysis system may be encrypted for security purposes. Similarly any reports and/or alerts provided to pre-designated recipients may also be encrypted or otherwise secured. The security measures may be based on policy rules of the system, user profiles, network types, and similar aspects of a system according to embodiments.

In addition to providing instructions to the routing/hub device and reports/alerts to pre-designated recipients, data repository and analysis system may also provide additional information to its routing/hub devices. The additional information may include instructions associated with the monitored condition to each user such as informative explanations, warnings, training material, and so on. In case of medical conditions, information with nearby healthcare providers, pharmacies, or even new prescriptions may be transmitted via the routing/hub device. The additional information may also include marketing related material such as discount coupons for required medication, equipment, informative seminars, and the like. The information transmitted to the routing/hub devices may come from source other than the healthcare provider or the data repository and analysis system manager for forwarding to relevant users (based on monitored condition, location, and other criteria).

While the example systems, modules, communication modes, interface mechanisms are described with exemplary features, embodiments may be implemented with any of those protocols and features, as well as additional ones, using the principles described herein.

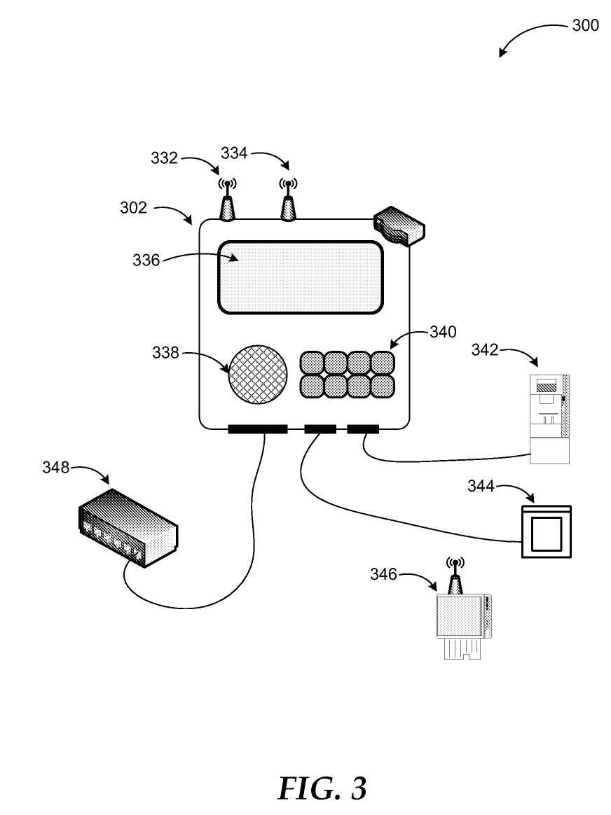

FIG. 3 illustrates an example routing/hub device managed by a data repository and analysis system according to embodiments. The core functionality of routing/hub device 302 as shown in diagram 300 includes interfacing with one or more test and monitoring devices (342, 344, 346), configuring them, receiving collected data, forwarding collected data to a central repository, and providing ancillary functions such as issuing alerts to predefined destinations, instructing complicated test and monitoring devices to perform functions in addition to testing and/or monitoring. Such functionality can be provided through custom or generic hardware platforms. Routing/hub device 302 is an example of custom hardware implementation.

Routing/hub device 302 may include common user interface components such as display 336, custom button 338, keypad 340, etc. for user input associated with various functions. Since each test and monitoring end device may have a unique (or standardized) communication interface, routing/hub device 302 may be configured to accommodate a variety of physical and programmatic interfaces. These capabilities also include accommodation of various Application Programming Interfaces (APIs) for various end devices. The physical capabilities include different wired and wireless communication interfaces such as Universal Serial Bus (USB), IEEE 1394®, RJ11, RJ45, and the like for wired connections. For wireless connections, a variety of short and long range communication protocols may be employed as well. Examples of such protocols include Wireless LAN (WLAN) protocols, short range low power communication protocols, optical communication protocols, as well as any long range communication systems. Physical and programmatic communication interfaces are well known in the art and not discussed here in exhaustive detail. Embodiments may be implemented using any interface available.

Routing/hub device 302 provides data collected from managed test and monitoring devices to a data repository and analysis system as discussed previously. The data repository and analysis system may also be responsible for configuring the routing/hub device software and its hardware platform. As mentioned before, some of the tasks associated with gathered data may be performed locally by the routing/hub device 302.

Communication with various test and monitoring end devices (e.g. 342, 344, and 346) may be accomplished through wired connections or wireless connection (e.g. one or both of antennas 332, 334) as shown in the figure. Routing/hub device 302 may correspond with other communication devices as well as data management systems through wired and wireless means as well. Since the communication means for different device types is likely to be different (e.g. short range vs. long range or private vs. public network), two or more different communication interfaces (e.g. antennas 332, 334) may be integrated to the routing/hub device 302.

One example of wired communication is switch 348, which may be connected to routing/hub device through an RJ11 or RJ45 type connection and provide access to Public Switched Telephone Network (PSTN). Thus, if an alert condition is satisfied based on the collected data, routing/hub device 302 may place a call over the PSTN to a designated phone number and provide a voice or data alert. Similarly, communication may be established over cellular networks, wired/wireless data networks (e.g. an enterprise network), or even a unified communications network. The same or other connections may also be used to communicate with the data repository and analysis system managing the routing/hub device 302.

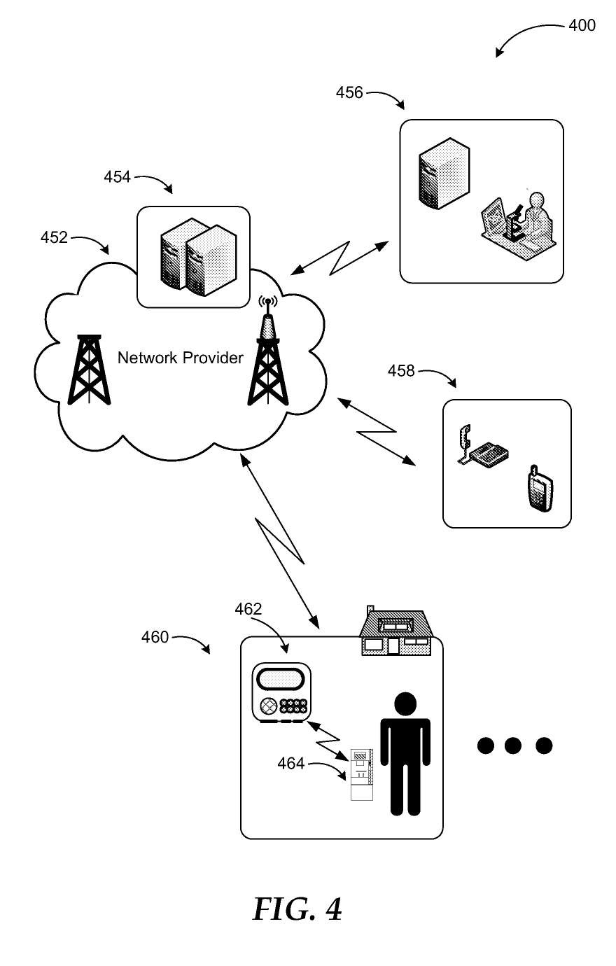

FIG. 4 is a conceptual diagram illustrating communications between major components of an example medical test and monitoring device management system according to embodiments.

A common usage scenario for a number of embodiments is envisioned in the medical services area. As discussed previously, healthcare test and monitoring is currently in a less than efficient and desirable state. While personal test and monitoring devices are available, many are not configured to interface with larger data management systems in an efficient manner. Healthcare facility based systems are typically cumbersome, costly, and impractical for home use.

Thus, a system according to embodiments may utilize a routing/hub device 462 to manage one or more test and monitoring devices (e.g. 464) at a patient's home 460 (e.g. a blood pressure monitor, a diabetes testing machine, etc.). The test and monitoring devices may be configured through the routing/hub device 462 to collect data periodically or otherwise. Depending on end device capability and configuration, end device 464 may communicate with the routing/hub device 462 wirelessly or through a wired communication. The communication between the routing/hub device 462 and the end devices does not need to be continuous. In some cases, the user may plug in the end device to the routing/hub device and download collected data at that time.

Routing/hub device 462 in turn communicates through a communication network 452 managed by a network provider with a data repository and analysis system 454 operating as part of the network. According to the illustrated example scenario, data repository and analysis system 454 may be established and operated by the network provider. Data from routing/hub device 462 may be processed, analyzed, and stored by the data repository and analysis system 454. Actions such as providing reports to healthcare providers 456, alerting emergency service providers, messages to pharmacies, family members, and so on (as exemplified by recipient devices 458) may be performed by the data repository and analysis system 454 based on predefined and/or customized rules associated with the collected data.

By using such a modular and customizable system, basic healthcare functionality can be extended beyond the hospitals, offices, and labs into an ever-present wireless environment with Internet connectivity, making healthcare providers more efficient and increasing healthcare system's capacity. Moreover, healthcare consumers can be equipped with the ability to generate and monitor their own medical data as it flows into a secure web portal that they, their advocates, and their chosen care providers may access to collaborate on the best course of action. Furthermore, a pull-through market mechanism can be created that equips healthcare consumers with the tools they need to make better healthcare choices and communicate more efficiently with their healthcare providers regarding their treatment options.

Commercially available medical testing components may be managed by such a system utilizing one or more standard technologies such as photochemical, spectroscopic, electrochemical, or micro-needle, or other miniaturized means of in vitro or in vivo testing of bodily fluids or tissue samples such as lab-on-chip to quantify one or more metabolites in a blood, urine, saliva or interstitial fluid or body tissue sample (i.e. glucose blood testing).

Data repository and analysis system 454 may also receive input from additional devices associated with the user of the routing/hub device 462 such as location detection services to provide the location of the patient to healthcare/emergency service providers should the patient become incapacitated. Medical conditions where the user of a system as described above may be useful include blood pressure/cholesterol/heart rate monitoring, medication intake monitoring, diabetes testing, cancer, obesity, HIV, end-of-life care, and other chronic/sub-acute/acute conditions.

By being an independent entity monitoring and analyzing collected data, data repository and analysis system 454 may interact with a plurality of healthcare providers and other service providers enabling the patient to receive services from multiple service providers without having to deal with setting up distinct services with each one. For example, collected data may be provided to the patient's primary care physician, specialist, and pharmacy, all of which may be separate and distinct entities. This optimized service connection would not only reduce the cost of monitoring services, but allow patients to receive those services in an automated and reliable manner.

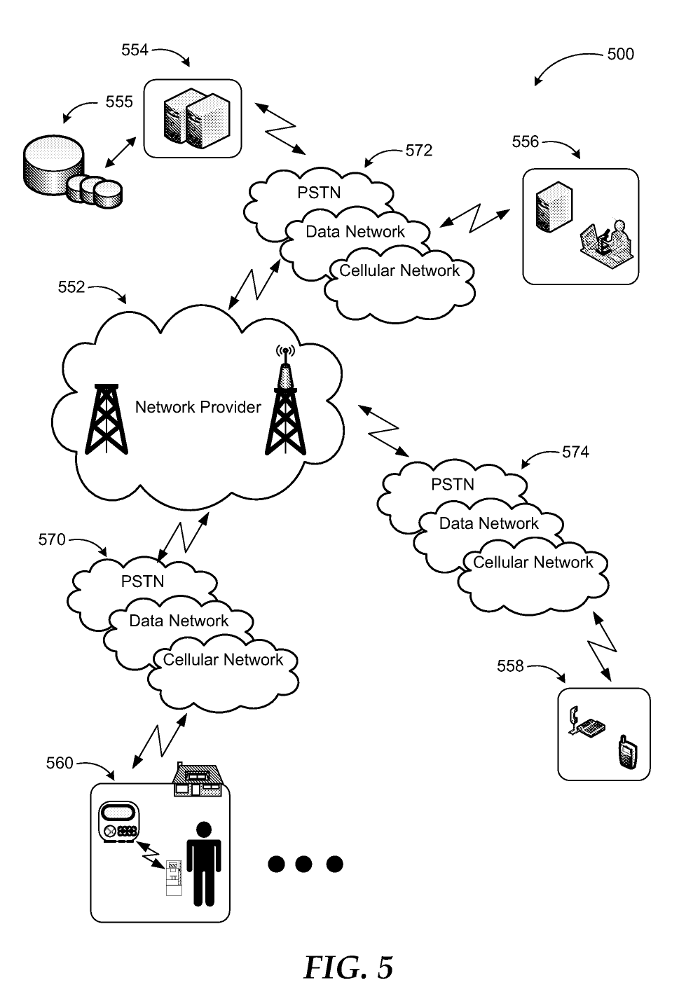

FIG. 5 illustrates a networked environment where embodiments may be implemented. Test and monitoring device management as described previously may be implemented locally or in a distributed manner over a number of physical and virtual clients and servers. Such a system may typically involve one or more networks 570, 572, 574, which may include one or more of PSTN, cellular network, data network, and others. At least one of the systems may be implemented in un-clustered systems or clustered systems employing a number of nodes communicating over one or more networks.

At the core of a system according to embodiments may be a network provider's network comprising any topology of servers, clients, Internet service providers, and communication media. Also, the system may have a static or dynamic topology. The term “client” may refer to a client application or a client device. A system according to embodiments may involve many more components, typical and relevant ones are discussed in conjunction with this figure.

A data repository and analysis system may be executed over one or more servers 554 associated with the network provider's network 552 or on a third party service provider's servers. Servers 554 may store data and configuration information on data stores 555 and communicate with report recipients (e.g. healthcare providers) 556 through network(s) 572. Routing/hub devices locally managing and collecting data from a number of peripheral test and monitoring devices (560) may communicate with the data repository and analysis system through network(s) 570. In response to detecting alert conditions, alert messages/calls may be sent to alert recipients 558 through network(s) 574 by the data repository and analysis system or directly by the routing/hub devices.

Network(s) 570, 572, and 574 may be anyone of the example networks shown. They may also be integrated or distinct networks communicating through common nodes. Communication between any nodes described in the diagram 500 may include wired media such as a wired network or direct-wired connection, and wireless media such as acoustic, RF, infrared and other wireless media.

Many other configurations of computing devices, applications, data sources, and data distribution systems may be employed to implement test and monitoring device management. Furthermore, the networked environments discussed in FIG. 5 are for illustration purposes only. Embodiments are not limited to the example applications, modules, or processes.

While the example devices, systems, and scenarios in FIGS. 4 and 5 have been described with specific components and features, embodiments are not limited to these components or system configurations and can be implemented with other system configuration employing fewer or additional components. Functionality of the systems enabling test and monitoring device management through a data repository and analysis system may also be distributed among the components of the systems differently depending on component capabilities and system configurations.

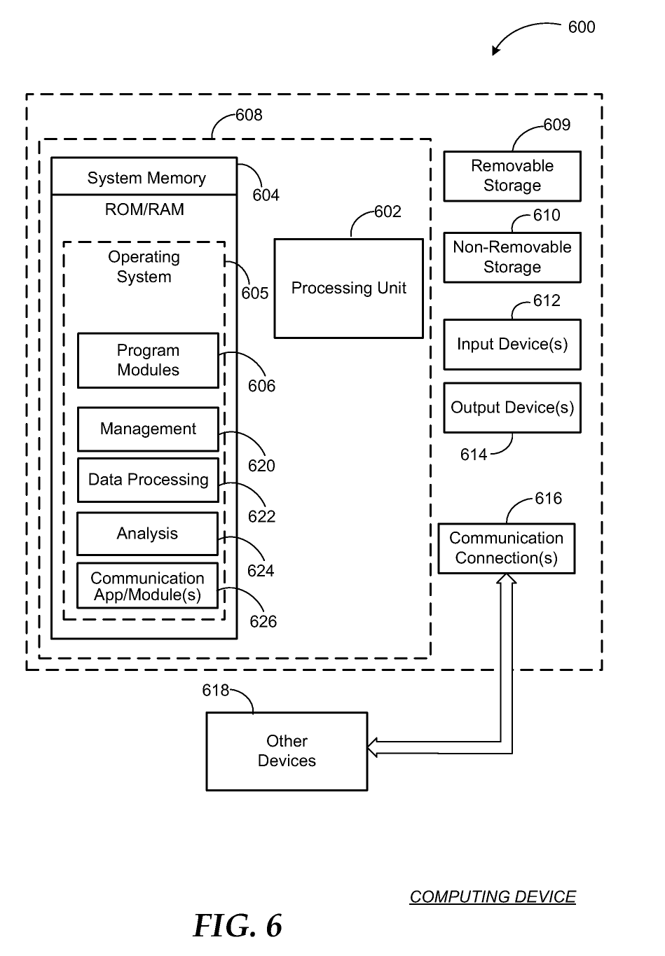

FIG. 6 and the associated discussion are intended to provide a brief, general description of a suitable computing environment in which embodiments may be implemented. With reference to FIG. 6, a block diagram of an example computing operating environment is illustrated, such as computing device 600. In a basic configuration, the computing device 600 may be a server executing at least a portion of programs associated with a data repository and analysis system as discussed above. Computing device 600 may typically include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the computing device. The system memory 604 may also include one or more software applications such as program modules 606, management application (or modules) 620, data processing application (or modules) 622, analysis application (or modules) 624, and communication applications/modules 626.

Device management application/modules 620 manages any connected routing/hub devices through preconfigured rules or inputs from local or remote input systems. In managing the routing/hub devices, device management application 620 may utilize one or more APIs to interface with the individual devices. Data processing application/modules 622 is configured to process collected data, facilitate storage/compression/decompression, formatting, and the like. Analysis application/modules 624 is configured to analyze the collected data according to predefined rules and generate reports for submission to designated recipients. Communication applications/modules 626 may be separate applications or integral modules of the computing device to provide advanced communication services with peripheral and remote devices and systems. This basic configuration is illustrated in FIG. 6 by those components within dashed line 608.

The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 612 such as keyboard, mouse, pen, voice input device, touch input device, etc. Output device(s) 614 such as a display, speakers, printer, etc. may also be included. These devices are well known in the art and need not be discussed at length here.

The computing device 600 may also contain communication connections 616 that allow the device to communicate with other devices 618, such as over a wireless network in a distributed computing environment, for example, an intranet or the Internet. Other devices 618 may include client devices and servers of the communication network, communication devices designated to receive alerts/messages, routing/hub devices and the like, as discussed above. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The claimed subject matter may also be implemented as methods. These methods can be implemented in any number of ways, including the structures described in this document. One such way is by machine operations, of devices of the type described in this document. Another optional way is for one or more of the individual operations of the methods to be performed in conjunction with one or more human operators performing some. These human operators need not be collocated with each other, but each can be only with a machine that performs a portion of the program.

Any operations performed by the data repository and analysis system or other components of a system according to embodiments for managing test and monitoring devices may be implemented by similar processes with fewer or additional steps, as well as in different order of operations using the principles described herein.

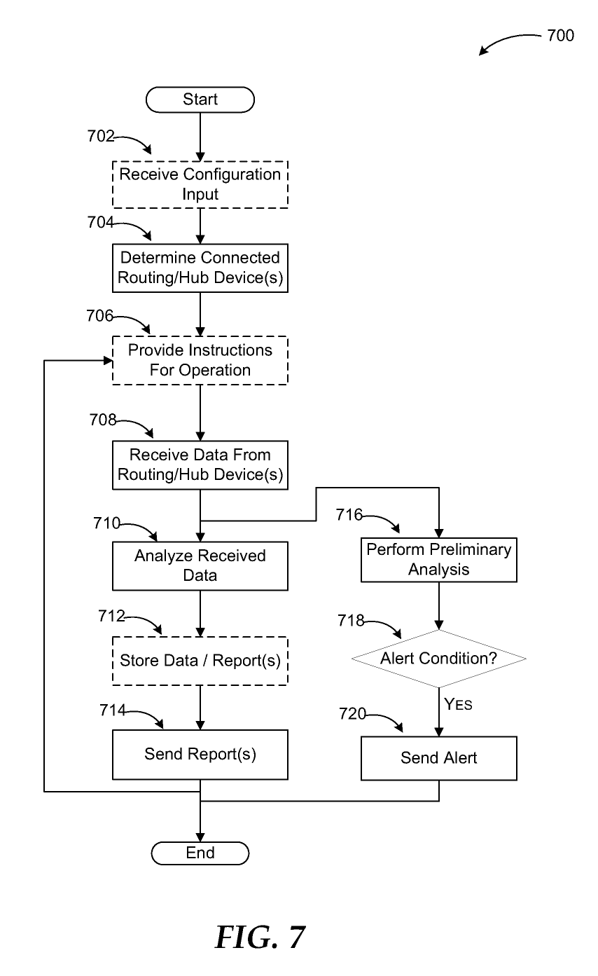

FIG. 7 is a flowchart of a process for managing test and monitoring end devices by a data repository and analysis system according to embodiments. Many of the operations described below are optional operations that are not essential for the core operation of a system according to embodiments. They have been included for completeness and illustration of potential breadth of a system according to embodiments.

A typical operation may begin with the data repository and analysis system receiving configuration input from users at optional operation 702. While some or all of the operations may be performed based on predefined rules, users of the system may also be given the option of customizing those rules and making selections among available choices (e.g. period of data collection, communication method, report parameters, etc.).

Processing then proceeds to operation 704, where connected routing/hub devices are determined. As discussed previously, APIs (and drivers) for routing/hub devices as well as test and monitoring end devices may be provided/updated by the data repository and analysis system.

At next optional operation 706, instructions (if any) are provided to the routing/hub devices regarding data collection and communication operations (data collection modes, communication protocols, media, and so on). Processing moves to operation 708 from optional operation 706, where collected data is received from the connected routing/hub devices. After operation 708, processing branches to two alternative paths. According to one path, a preliminary analysis may be performed to determine if any alert conditions are detected at operation 716. If any alert conditions are detected (decision operation 718), an alert in one of the forms discussed previously may be transmitted to one or more designated alert recipients at operation 720.

On the main branch of processing following operation 708, the received data is analyzed according to predefined (and customized) rules by the data repository and analysis system at operation 710. At subsequent optional operation 712, the analyzed data and any associated reports may be stored in data stores associated with the system. Following optional operation 712, reports generated based on the analysis are transmitted to report recipient(s) at operation 714.

According to some embodiments, processing may return to operation 706 after operation 714, where new configuration input may be received from users (e.g. report recipients) based on the analysis results and new instructions provided to the routing/hub devices.

Any operations performed by the data repository and analysis system or other components of a system according to embodiments for managing test and monitoring devices may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method of operating a data repository and analysis system for managing a plurality of test and monitoring end devices, the method comprising:
determining a subscribing routing/hub device associated with at least one test and monitoring end device;
determining a set of operational parameters for the subscribing routing/hub device;
transmitting the set of operational parameters to the subscribing routing/hub device;
receiving data collected by the at least one test and monitoring end device from the routing/hub device;
analyzing the received data based on a predefined template;
generating a report based on the analysis;
storing at least one of the received data, analysis results, and the generated report; and
providing the generated report to at least one designated report recipient.

2. The method of claim 1, further comprising:
determining whether an alert condition is present based on the analysis results; and
if the alert condition is present, transmitting one of: an audio alert, a video alert, a text message, a voice message, and a data upload to a predefined communication end device directly through at least one from a set of: a wireless public network, a wireless private network, a wired public network, a wired private network, and the Internet.

3. The method of claim 2, wherein the predefined communication end device is designated by one of: a user of the routing/hub device and the at least one report recipient.

4. The method of claim 1, wherein the predefined template includes at least one analysis rule selected by a subscriber among a plurality of available analysis rules and at least one custom rule defined by the subscriber.

5. The method of claim 4, wherein the subscriber is one of: a user of the routing/hub device and a report recipient.

6. The method of claim 4, further comprising:
generating a profile associated with a user of the routing/hub device;
generating another profile associated with each report recipient; and
enabling access to the collected data, the generated report, and any operational configuration based on the generated profiles.

7. The method of claim 6, further comprising:
formatting the generated report based on the other profile of the report recipient;
selecting a communication medium for the routing/hub device based on the profile of the user of the routing/hub device;
selecting a communication medium for providing the generated report based on the other profile of the report recipient; and
configuring the at least one test and monitoring end device based on the profile of the user of the routing/hub device.

8. The method of claim 1, wherein transmitting the set of operational parameters to the subscribing routing/hub device comprises:
transmitting at least one from a set of: a preferred communication interface, a preferred communication protocol, and an Application Programming Interface (API) for the at least one test and monitoring end device through a standard communication means; and
transmitting updates to at least one from a set of: a preferred communication interface, a preferred communication protocol, and an Application Programming Interface (API) for the at least one test and monitoring end device.

9. The method of claim 1, wherein the at least one test and monitoring end device is a medical condition monitoring device, a user of the routing/hub device is a patient, and the at least one designated report recipient is a healthcare provider.

10. A system for managing a plurality of medical condition test and monitoring end devices, the system comprising:
a routing/hub device managing at least one medical condition test and monitoring end device locally through a short range communication connection;
a data repository and analysis system executed on at least one server, the data repository and analysis system configured to:
determine a set of operational parameters for the routing/hub device based on a set of preconfigured and customizable templates for health conditions;
transmit instructions based on the determined set of operational parameters to the routing/hub device;
receive data collected by the at least one medical condition test and monitoring end device from the routing/hub device;
analyze the received data based on the set of preconfigured and customizable templates for health conditions;
generate a report based on the analysis in a format defined by one of a patient using the routing/hub device and a healthcare provider;
store at least one of the received data, analysis results, and the generated report; and
provide the generated report to the healthcare provider.

11. The system of claim 10, wherein the data repository and analysis system is further configured to:
perform at least one of data mining on stored data and trending analysis on received data; and
provide another report based on the data mining and trending analysis to a designated recipient.

12. The system of claim 10, wherein the healthcare provider includes at least one from a set of: a primary care physician, a specialist physician, a pharmacy, and a healthcare management entity.

13. The system of claim 10, wherein the set of operational parameters includes a communication medium, a communication protocol, a data collection mode, a data collection frequency, a data transmit frequency, and a data transmit format.

14. The system of claim 10, wherein the data repository and analysis system is further configured to:
provide instructions to a peripheral device associated with the test and monitoring end device capable of administering one of: a medication and a non-chemical therapeutic action.

15. The system of claim 10, wherein the data repository and analysis system is a component of a hosted service operated by a communication network provider.

16. A computer-readable storage medium with computer-executable instructions stored thereon for managing a plurality of medical test and monitoring devices, the instructions comprising:
determining a routing/hub devices managing at least one medical test and monitoring devices locally;
determining a set of operational parameters for each routing/hub device based on a set of preconfigured and customizable templates for health conditions;
transmitting the set of operational parameters to the routing/hub devices through at least one from a set of: a wireless public network, a wireless private network, a wired public network, a wired private network, and the Internet;
receiving data collected by the at least one medical test and monitoring device associated with each routing/hub device from respective routing/hub devices;
analyzing the received data based on the respective set of preconfigured and customizable templates;
generating reports based on the analysis;
storing at least one of the received data, analysis results, and the generated report in one of a local data store and a remote data store; and
providing the generated reports to designated report recipients associated with each routing/hub device;
determining whether an alert condition is present based on the analysis results; and
if the alert condition is present, transmitting one of: an audio alert, a video alert, a text message, a voice message, and a data upload to a predefined alert recipient directly through at least one from a set of: a wireless public network, a wireless private network, a wired public network, a wired private network, and the Internet.

17. The computer-readable storage medium of claim 16, wherein the instructions further comprise:
configuring a format and determining a communication mode for each report based on at least one of: a subscriber selection and a report recipient selection, wherein the subscriber is a patient using one of the routing/hub devices.

18. The computer-readable storage medium of claim 16, wherein the instructions further comprise:
transmitting instructions to a routing/hub device for configuring a medical test and monitoring device managed by that routing/hub device in response to one of: receiving instructions from an associated report recipient and a predefined rule in a preconfigured and customizable template used for the routing/hub device.

19. The computer-readable storage medium of claim 16, wherein the instructions further comprise:
periodically determining whether at least one of an operational software and an API associated with the routing/hub devices and their respective medical test and monitoring devices is to be updated; and
if an update is determined, transmitting relevant updates to the affected routing/hub devices.

20. The computer-readable storage medium of claim 16, wherein the instructions further comprise:
enabling additional report recipients to receive reports associated with a subscriber using a routing/hub device based on permission from the subscriber.
